(19) United States
(12) Patent Application Publication
(10) Pub. No.: US 2019/0229526 A1
(43) Pub. Date: Jul. 25, 2019

(54) CIRCUIT SYSTEM FOR COUPLING AN ELECTRICAL CONTROL UNIT TO A VOLTAGE SUPPLY, AND ELECTRICAL CONTROL UNIT

(71) Applicant: Robert Bosch GmbH, Stuttgart (DE)

(72) Inventors: Alexander Hey, Backnang (DE); Fabian Wingert, Wehingen (DE); Martin Buecker, Heilbronn (DE); Oda Limbach, Stuttgart (DE); Simon Riedel, Grossbottwar (DE); Stefan Hoess, Hessigheim (DE); Thomas Saile, Forchtenberg (DE); Volker Weeber, Lauffen A. N. (DE)

(21) Appl. No.: 16/327,119

(22) PCT Filed: Aug. 15, 2017
(86) PCT No.: PCT/EP2017/070666

§ 371 Date: Feb. 21, 2019

(30) Foreign Application Priority Data
Aug. 22, 2016 (DE) 10 2016 215 688.8

(51) Int. Cl. H02H 9/00; H02H 7/06

(52) U.S. Cl. CPC H02H 9/001; H02H 7/065

(57) ABSTRACT

A device for coupling a control unit with a voltage supply. An electrical connection between the voltage supply and the electrical control unit may be opened/closed with a switching element. An electrical resistor, which allows for a limited current flow from the voltage supply to the electrical control unit even when the switching element is open, is parallel to the switching element. Thus, an electrical energy store, such as a capacitor or a similar device, which is to buffer the input voltage at the electrical control unit, is chargeable even when the switching element is open. This is to avoid adverse effects caused by the charging of a capacitor at the input of the control unit when the switching element is closed.

### FIELD OF THE INVENTION

The present invention relates to a device for coupling an electrical control unit with a voltage supply, and to an electrical control unit having such a device. In addition, the present invention relates to an electrical drive system having an electrical control unit.

### BACKGROUND INFORMATION

Numerous electronic circuits such as electrical control units have an electrical energy store in the form of an electrical capacity. Especially in many control units in the automotive field, such electrical energy stores are provided in the form of capacitors or similar devices. Such electrical energy stores make it possible to compensate for voltage fluctuations of a supplying electrical energy source or possibly also to maintain the function of the control unit for a predefined period of time in the event that the connected voltage source fails or is cut off for reasons of safety.

Such electrical energy stores are usually made up of one or a plurality of capacitor(s). If a control unit having such an electrical energy store is switched off or deactivated, then an electrical connection between the voltage source and the electrical energy store is able to be interrupted. When the control unit is turned on or activated, the electrical connection between the voltage source and the electrical energy store is reestablished in that, for example, an electrical switch is closed. Following the closing of the switch, an electrical current immediately starts to flow from the voltage source into the electrical energy store in order to charge the electrical energy store. This electrical current is limited only by line resistances, line inductivities and possibly further parasitic components. In the case of electrical energy stores having a large capacity, this normally leads to a high cut-in current. Since this high cut-in current may possibly lead to significant loading of the electrical voltage source, circuit systems are usually provided which limit a cut-in current during the connection of the electrical energy store to a voltage source.

The printed publication DE 10 2013 106 854 A1 discusses a circuit for limiting the cut-in current. A series circuit made up of a switching element and an inductivity is provided between a connection point of a voltage source and a connection point of a capacitor. Furthermore, a control is provided, which is configured to operate the switch and the inductivity in a continuous current mode in order to charge the capacitor.

### SUMMARY OF THE INVENTION

The present invention describes a device for coupling an electrical control unit with a voltage supply having the features described herein, an electrical control unit having the features described herein, and an electrical drive system having the features described herein.

Accordingly, it is provided:

A device for coupling an electrical control unit with a voltage supply having a first input connection, which is able to be coupled with a first connection of the voltage supply, a second input connection, which is able to be coupled with a second connection of the voltage supply, a first output connection, which is able to be coupled with a first connection of the electrical control unit, and a second output connection, which is able to be coupled with a second connection of the electrical control unit. In addition, the device includes a switching element, which is situated between the first input connection and the first output connection; and an electrical resistor, which is situated between the first input connection and the first output connection. As a result, the electrical resistor is disposed parallel to the switching element between the first input connection and the first output connection.

In addition, it is provided:

An electrical control unit which has a circuit system according to the present invention for coupling the electrical control unit with a first voltage supply, and a capacitor. The capacitor is connected via a first connection to the first output connection of the device for coupling the electrical control unit. Furthermore, the capacitor is connected via a second connection to the second output connection of the device for coupling the electrical control unit.

Moreover, it is provided:

An electrical drive system which includes an electrical machine, a power converter, which is developed to supply a predefined electrical voltage at the electrical machine, and an electrical control unit according to the present invention. The control unit is developed to supply control signals for actuating the power converter at the power converter.

The present invention is based on the understanding that when an electrical energy store such as a capacitor having a high capacitance is connected, an electrical charging current begins to flow immediately. As a rule, the magnitude of this electrical charging current is limited only by the characteristics of the connection elements between the electrical energy store and the voltage source. Such high charging currents during charging of an electrical energy store after the electrical energy store has been connected to a voltage source may place a heavy load on the voltage source. For example, a brief voltage drop may occur at the voltage source. Without further restriction, the high charging currents during charging the electrical energy store may furthermore possibly also heavily load electrical components such as switching elements or similar parts that are disposed in the electrical current path between the voltage source and the electrical energy store. Conventional cut-in current limitations that are able to limit the maximum charging current for charging the electrical energy store are normally quite costly and possibly also require a complex actuation.

Therefore, one idea of the present invention is to take this recognition into account and to provide a device for coupling a voltage supply with an electrical energy store that largely avoids the occurrence of high electric currents. Toward this end, a control unit having an electrical energy store is coupled with a voltage supply with the aid of a switching element. This switching element, for example, may be a semiconductor switch such as a MOSFET or a bipolar transistor having an insulated gate connection (IGBT), or a similar device. In addition, however, mechanical switching element or similar components are also an option. Parallel to this switching element, an electrical resistor such as an ohmic resistor is furthermore provided. This resistor, for example, may be a relatively high-impedance electrical resistor. Via this high-impedance electrical resistor, a relatively low electrical current may flow between the electrical energy store and the voltage source when the switching element is open. However, in a deactivated or switched-off control unit, this low electrical current is sufficient to charge the electrical energy store. In this way, an approximately equal electrical potential comes about between the two connections of an open switching element between the electrical energy store and the voltage supply. The switching element may therefore be closed without a greater electric current beginning to flow when closing the switching element. On the other hand, by suitable dimensioning of the electrical resistor parallel to the switching element, it is possible to restrict the maximum electrical power. It can therefore also be ensured that in the event of a fault in the control unit such as a short-circuit or a similar event, no significant current flow is going to occur between the voltage source and the electrical energy store, and thus also between the voltage source and the control unit, when the switching element is open. Through an appropriate dimensioning of the resistor parallel to the switching element, it is also possible to adequately restrict the maximum current in such a way that no current of a magnitude that could lead to a thermal event or a similar occurrence is able to flow even during a short-circuit in the control unit. Therefore, the safety of the system as a whole continues to be ensured.

The placement of an electrical resistor parallel to the switching element constitutes a very simple and cost-effective solution. No additional further components, especially a complex circuit system or a control for limiting a cut-in current, are required. The complexity of the system as a whole is thereby able to be reduced. The error susceptibility and also the costs can be considerably lowered in this way.

According to one specific embodiment, the circuit system furthermore includes a diode, which is disposed in series with the electrical resistor between the first input connection and the first output connection of the device for coupling the electrical control unit with the voltage supply. Thus, a series connection, which is made up of a diode and an electrical resistor, is provided parallel to the switching element. This makes it possible to realize a simple protection against an incorrect polarity connection during the connection of the control unit.

According to one further embodiment, the device includes a control unit. The control unit is developed to actuate the switching element. Through an actuation of the switching element with the aid of the control unit, an electrical connection between a first input connection and the first output connection is closed. In this way, the control unit may enable the electrical connection between the voltage source and the control unit.

According to one specific embodiment of the electrical control unit, the electrical resistor which is provided between the first input connection and the first output connection is adapted as a function of the capacitance of the capacitor between the first output connection and the second output connection. In particular, the resistance may be dimensioned as large as possible in order to keep the currents across the path with the resistor low. In this way the power loss in the resistor which is created in the event of a fault is negligibly small. On the other hand, the resistance should be selected as small as possible so that charging of the capacitor is able to be carried out within a reasonable time. For example, resistance values R and capacitance value C that result in a time constant in a range of R*C between 10 s and 100 s are suitable.

According to one specific embodiment, the control unit has a control input. The control unit is able to be activated with the aid of an activation signal that is applied at the control input. This makes it possible to selectively activate and/or deactivate the control unit using this activation signal. The control unit may therefore be deactivated or set to a readiness/standby mode, for example, although a voltage which lies in the range of the supply voltage of the control unit is applied across the electrical resistor parallel to the switching element at the control unit.

According to one specific embodiment, the first input connection and the second input connection of the device for coupling the control unit with the voltage supply are electrically coupled with a vehicle electrical system of a motor vehicle. As a rule, a vehicle electrical system of a motor vehicle is supplied by a 12 volt or 24 volt battery. Due to the avoidance of high cut-in currents during the charging of an electrical energy store in a control unit according to the present invention, voltage drops due to the limited capacity of the batteries are able to be reduced.

The above embodiments and further developments are able to be combined with one another as desired and to the extent it appears meaningful. Additional embodiments, further developments and implementations of the present invention also include not explicitly mentioned combinations of features of the present invention described previously or in the following text in connection with the exemplary embodiments. In particular, one skilled in the art will also add individual aspects as improvements or supplementations to the respective base forms of the present invention.

In the following text, the present invention will be described in greater detail based on the exemplary embodiments indicated in the schematic figures of the drawings.

Unless stated to the contrary, similar or functionally equivalent elements and devices have been provided with the same reference numerals in all of the figures.

### BRIEF DESCRIPTION OF THE DRAWINGS

FIG. 1 shows a schematic illustration of an electrical control unit having a device for coupling the control unit with a voltage supply according to one embodiment.

FIG. 2 shows a schematic illustration of an electrical control unit having a device for coupling the control unit with a voltage supply according to one further embodiment.

FIG. 3 shows a schematic illustration of an electrical drive system according to one embodiment.

### DETAILED DESCRIPTION

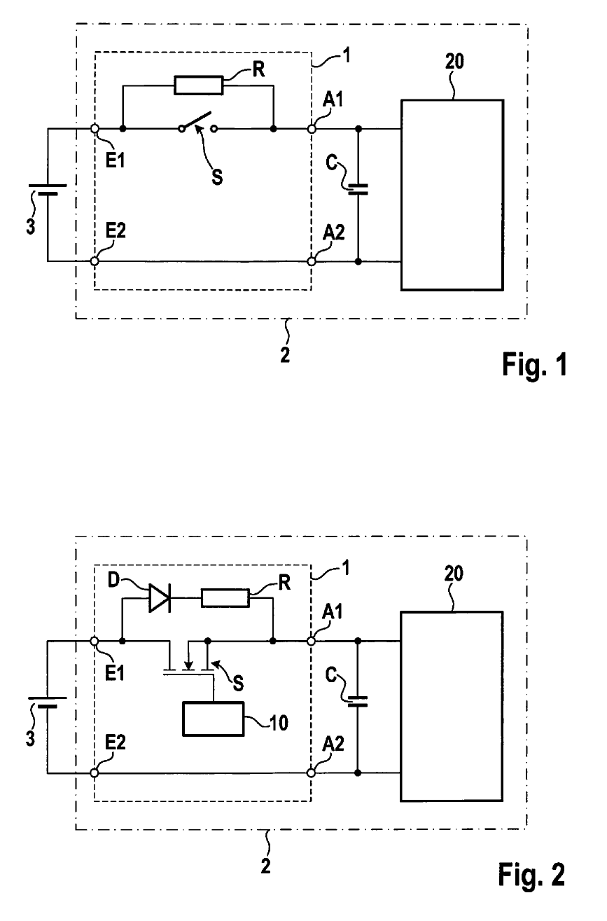

FIG. 1 shows a schematic illustration of an electrical control unit 2 according to one specific embodiment. Electrical control unit 2 may be any electrical control unit, in particular an electrical control unit for a motor vehicle. Such control units 2 may be used for the control of electrical drive systems in electric or hybrid vehicles, for example. In addition, various other electrical control units are possible, e.g., electrical control units for different electric motors, in particular in a motor vehicle. However, electrical control units for other application purposes such as for the control of an airbag system in a vehicle or similar purposes are also possible.

Control unit 2 includes a control device 20, for example. This control device 20, for instance, may be configured to receive and evaluate various input signals. In addition, depending on the application case, control device 20 is able to generate suitable control signals based on the processing results of control device 20 and supply them at an output (not shown here).

To process the input signals and/or to generate the output signals, control device 20 has to be supplied with electrical energy. To stabilize an input voltage of control device 20 and/or to maintain a supply voltage even during a failure of the energy supply, an electrical energy store C, e.g., in the form of one or a plurality of capacitors, is situated at the input connections where the voltage supply is made available. If, as illustrated here, control device 20 is to be supplied with a direct voltage, then electrical energy store C may have two connections, for instance, one connection in each case being electrically connected to an input connection for the input voltage on control device 20. In addition, the two input connections for the input voltage of control device 20 are coupled via a device 1 with a voltage supply 3. Voltage supply 3 may be any voltage source, in particular any direct voltage source. For example, voltage supply 3 may include a battery or an accumulator. In particular, voltage supply 3 may involve a vehicle electrical system of a motor vehicle which is fed from a vehicle battery, for example.

A first connection of voltage supply 3 is connected to a first input connection E1 of device 1 for coupling electrical control unit 2 with voltage supply 3. A further connection of voltage supply 3 is connected to a second input connection E2 of device 1 for coupling electrical control unit 2 with voltage supply 3.

In addition, a first output connection A1 is coupled with a first connection for the voltage supply of electrical control unit 2, in particular for the voltage supply of control device 20. In the same way, a second output connection A2 is coupled with a second connection of electrical control unit 2, in particular a second connection for the voltage supply of control device 20. In the exemplary embodiment shown here, second input connection E2 is electrically connected to second output connection A2. It is basically also conceivable that the second connection of voltage supply 3 thus is also directly connected to the second connection for the voltage supply of electrical control unit 2. In addition, it is also conceivable that an identical or equivalent circuit system is provided between second input connection E2 and second output connection A2 as it will be described in the following text between first input connection E1 and first output connection A1.

A switching element S is situated between first input connection E1 and first output connection A1 of device 1 for coupling electrical control unit 2 with voltage supply 3. This switching element S may be any switching element that is suitable to interrupt an electrical connection between first input connection E1 and first output connection A1 or to close it if necessary. For example, switching element S may be a mechanical switching element. In addition, however, electronic switching elements such as semiconductor switching elements in the form of a MOSFET or a bipolar transistor having an insulated gate connection (IGBT) are also possible. Moreover, any other additional mechanical or electronic switching elements are an option.

In addition, an electrical resistor is furthermore disposed between first input connection E1 and first output connection A1 parallel to switching element S. This electrical resistor R may be an ohmic resistor. Via this resistor R, which is situated parallel to switching element S between first input connection E1 and first output connection A1, an electrical current from voltage supply 3 may therefore flow in the direction of electrical energy store C also when switching element S is open. While switching element S is open, an electrical current will flow from voltage supply 3 into electrical energy store C until electrical energy store C has been charged to the voltage that approximately corresponds to the voltage that is supplied by voltage supply 3 (minus possibly occurring voltage drops across further, e.g., parasitic, components). Thus, approximately the same potential will come about on both sides of switching element S when switching element S is open. If switching element S is closed at a later point in time, then no significant current will initially flow through switching element S as long as electrical energy store C has not been discharged. As a result, no significant current flow initially takes place from voltage supply 3 in the direction of electrical energy store C when switching element S is closed, and voltage supply 3 will therefore not be loaded to any significant degree during the closing of switching element S.

FIG. 2 shows a schematic illustration of a control unit 2 according to one further specific embodiment. Control unit 2 according to this embodiment essentially corresponds to control unit 2 according to the previously described embodiment. As illustrated in FIG. 2, switching element S (here illustrated by a semiconductor switching element) is able to be actuated by a control device 10. Switching element S may be closed by applying a control signal from control device 10 at a control connection of switching element S. Of course, various further approaches for actuating or opening and closing switching element S are possible in addition.

The exemplary embodiment according to FIG. 2 furthermore differs from the previously described exemplary embodiment in particular in that instead of electrical resistor R, a series connection, which is made up of a diode D, especially a semiconductor diode, and electrical resistor R, is disposed parallel to switching element S. It can thereby be ensured, for example, that in the event of a faulty connection of control unit 2 to voltage supply 3, electrical energy store C of control unit 2 will not be charged because diode D would be operated in the reverse direction in such a case. A voltage drop across diode D which occurs while electrical energy store C is charged may be disregarded and does not constitute a significant voltage drop that would lead to a noticeable adverse effect during the closing of switch S.

In addition, however, it is also possible to place a further electrical resistor (not shown here), e.g., parallel to diode D or parallel to the series connection of diode D and electrical resistor R, so that even a possible voltage drop across diode D is able to be compensated for by way of this further resistor. For instance, this further resistor may be selected one or more sizes larger than resistor R, which is provided in series with diode D.

In all exemplary embodiments, electrical resistor R may particularly be dimensioned as a function of a capacitance of electrical energy store C. The time period for charging electrical energy store C, for example, results from triple the product of electrical resistance R and the capacitance of electrical energy store C. Accordingly, given a predefined capacitance of electrical energy store C and a predefined time period for charging electrical energy store C, it is possible to calculate electrical resistance R.

When dimensioning electrical resistor R and electrical energy store C, the resistance should be dimensioned as large as possible in order to keep the currents across this branch low. In this way, a power loss produced in electrical resistor R in the event of a fault may be kept low. The power loss is approximately negligible in this case. On the other hand, electrical resistance R should be selected so small that charging of electrical energy store C may take place within a reasonable time. Suitable, for example, are resistance values for electrical resistance R and capacitance values for electrical energy store C that result in a time constant are at which the product of the resistance value and the capacitance value lies in a range of 10 s to 100 s. In addition to this value range, depending on the application case, it is of course also possible to select values that differ therefrom for electrical resistance R or for capacitance C.

In addition, a control input for activating and deactivating control unit 2 may be provided on control unit 2. For instance, using an activation signal applied at the control input, control unit 2 is able to be activated. This makes it possible to selectively activate and/or deactivate control unit 2 with the aid of this activation signal. As the case may be, separate control inputs may also be provided on control unit 2 for the activation and deactivation. As a result, control unit 2 is able to be deactivated or set to a readiness/standby mode, for instance, despite an electrical voltage that approximately corresponds to the supply voltage being applied via electrical resistor R.

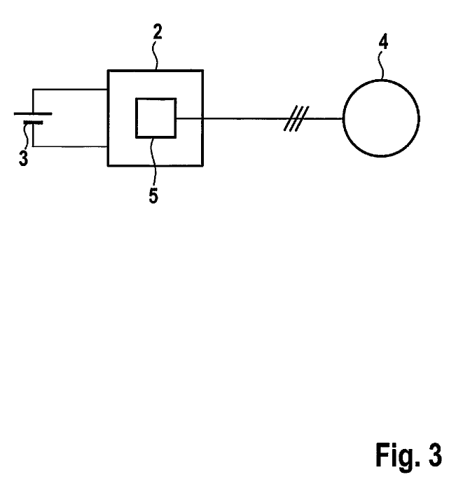

FIG. 3 shows a schematic illustration of an electrical drive system having an electrical control unit 2 according to one specific embodiment. The electrical drive system includes an electrical machine 4 and control unit 2 having a power converter 5. Power converter 5 supplies the electrical voltage at electrical machine 4 that is required to operate electrical machine 4. Power converter 5 is actuated by electrical control unit 2 in order to generate from a predefined input voltage an output voltage that is suitable for operating electrical machine 4.

In addition, any further applications of control units, in particular of control devices in motor vehicles, are of course possible. For this purpose, for example, the control units may be separated from electrical voltage supply 3 in a switched-off or deactivated state by opening switching element S. Control unit 2 generally consumes no electrical energy in this switched-off or deactivated state. By opening switching element S, it is possible to interrupt the voltage supply, for instance for safety reasons. If control unit 2 is subsequently to be switched on or activated, switching element S may be closed. Since electrical energy store C has previously been charged already via electrical resistor R, no high charging current is initially encountered from voltage supply 3 in the direction of electrical energy store C during the closing of switching element S. After switching element S has been closed, control unit 2 is able to start its operation. In the process, the input voltage for the voltage supply of control unit 2 is buffered by electrical energy store C. Even if voltage supply 3 fails, the operation of control unit 2 is able to be maintained for a predefined specific period of time on account of the electric energy stored in electrical energy store C.

In summary, the present invention relates to a device for coupling a control unit with a voltage source. An electrical connection between the voltage supply and the electrical control unit is able to be opened or closed with the aid of a switching element. An electrical resistor is provided parallel to the switching element, which allows for a limited current flow from the voltage supply to the electrical control unit even when the switching element is open. In this way, an electrical energy store such as a capacitor or a similar device, which is meant to buffer the input voltage at the electrical control unit, is also able to be charged when the switching element is in an open state. This makes it possible to avoid adverse effects caused by the charging of a capacitor at the input of the control unit while the switching element is closed.

1-8. (canceled)

9. A device for coupling an electrical control unit with a voltage supply, comprising:
a first input connection, which is coupleable with a first connection of the voltage supply;
a second input connection, which is coupleable with a second connection of the voltage supply;
a first output connection, which is coupleable with a first connection of the electrical control unit;
a second output connection, which is coupleable with a second connection of the electrical control unit;
a switching element, which is situated between the first input connection and the first output connection; and
an electrical resistor, which is situated between the first input connection and the first output connection.

10. The device of claim 9, further comprising:
a diode disposed in series with the electrical resistor between the first input connection and the first output connection.

11. The device of claim 9, further comprising:
a control device to actuate the switching element to close an electrical connection between the first input connection and the first output connection.

12. An electrical control unit, comprising:
a device for coupling an electrical control unit with a voltage supply, including:
a first input connection, which is coupleable with a first connection of the voltage supply;
a second input connection, which is coupleable with a second connection of the voltage supply;
a first output connection, which is coupleable with a first connection of the electrical control unit;
a second output connection, which is coupleable with a second connection of the electrical control unit;
a switching element, which is situated between the first input connection and the first output connection; and
an electrical resistor, which is situated between the first input connection and the first output connection; and
a capacitor, which is connected via a first connection to the first output connection of the device for coupling the electrical control unit and which is connected via a second connection to the second output connection of the device for coupling the electrical control unit.

13. The electrical control unit of claim 12, wherein a product of a value of the electrical resistance and a value of a capacitance of the capacitor is in a range of 10 to 100 seconds.

14. The electrical control unit of claim 12, wherein the first input connection and the second input connection of the device for coupling the control unit with the voltage supply is electrically coupled with a vehicle electrical system of a motor vehicle.

15. The electrical control unit of claim 12, wherein the control unit includes a control input and the control unit is activate-able with an activation signal that is applied at the control input.

16. An electrical drive system, comprising:
an electrical machine;
an electrical control unit, including:
a device for coupling an electrical control unit with a voltage supply, including:
a first input connection, which is coupleable with a first connection of the voltage supply;
a second input connection, which is coupleable with a second connection of the voltage supply;
a first output connection, which is coupleable with a first connection of the electrical control unit;
a second output connection, which is coupleable with a second connection of the electrical control unit;
a switching element, which is situated between the first input connection and the first output connection; and
an electrical resistor, which is situated between the first input connection and the first output connection; and
a capacitor, which is connected via a first connection to the first output connection of the device for coupling the electrical control unit and which is connected via a second connection to the second output connection of the device for coupling the electrical control unit;
wherein the control unit includes a power converter to supply a predefined electrical voltage at the electrical machine, and wherein the control unit is to supply a control signal for actuating the power converter at the power converter.
